(19) United States
(12) Patent Application Publication
(10) Pub. No.: US 2026/0133028 A1
(43) Pub. Date: May 14, 2026

(54) SYSTEM AND METHOD FOR DETECTING HIGH ASPECT RATIO MICRO-HOLES USING OPTICAL FREQUENCY DOUBLING TECHNOLOGY

(71) Applicant: SPIROX CORPORATION, Hsinchu City (TW)

(72) Inventors: Yao-Chou YANG, Hsinchu City (TW); Feng-Chieh LI, Hsinchu City (TW); Yen-Cheng CHAO, Hsinchu City (TW)

(21) Appl. No.: 19/199,763

(22) Filed: May 6, 2025

(30) Foreign Application Priority Data
Nov. 14, 2024 (TW) 113143875
Dec. 27, 2024 (TW) 113151357

(51) Int. Cl. G01B 11/24; G01B 11/22

(52) U.S. Cl. CPC G01B 11/24; G01B 11/22

(57) ABSTRACT

A system and method for detecting high aspect ratio micro-holes using optical frequency doubling technology, wherein the micro-hole includes, but is not limited to, a through silicon via (TSV), a through-glass via (TGV), and a through-SiC via (TSiCV). Scanning a fundamental frequency light of a specific wavelength along the axis of the micro-hole to generate strong interface-enhanced frequency-doubled signals at an interface between the micro-hole and another material, (including, but not limited to, air), thereby obtaining a micro-hole geometric structure image characterized by high resolution and visualization, wherein the micro-hole geometric structure image exhibits a high-intensity and distinct interface-enhanced frequency-doubled signal along the contour of the micro-hole, thereby enabling direct visualization of the micro-hole morphology and assessment of the structural quality of the micro-hole. Furthermore, the frequency-doubled signal can be further analyzed to perform high-precision measurement of the hole size, shape, surface roughness, defects, and cracks, which are applicable to process monitoring and quality control of high aspect ratio micro-holes.

### CROSS REFERENCE TO RELATED APPLICATIONS

This application claims priority of Application No. 113 143 875 filed in Taiwan on Nov. 14, 2024 and Application No. 113 151 357 filed in Taiwan on Dec. 27, 2024 under 35 U.S.C. § 119, the entire contents of all of which are hereby incorporated by reference.

### TECHNICAL FIELD

The present invention relates to an optical detection technology, and more particularly to an optical detection system and method for detecting high aspect ratio micro-holes, including but not limited to through silicon via (TSV), through-glass via (TGV) and a through-SiC via (TSiCV).

### BACKGROUND

Conventional optical measurement technology for through-silicon via (TSV) is based on optical principles and is employed to perform non-destructive measurement of TSV dimensional parameters, including size, shape, and depth. Conventional TSV optical measurement techniques includes the following categories:

Optical microscope: A high-magnification optical microscope is used to directly observe the morphology of TSV and obtain dimensional information through visual inspection or auxiliary measurement software.

Interferometric measurement method: The interference phenomenon of light is used to measure the depth and surface roughness of TSV. Common interferometric techniques include white light interferometry and phase-shift interferometry.

Confocal microscopy: A focused light beam is used to scan the surface of a sample, and a three-dimensional image is reconstructed based on detection of the returned light signal.

Optical profilometry: Based on the principle of optical triangulation, height information of the sample is obtained by measuring the reflection angles of light at different positions on the sample surface.

Conventional TSV optical measurement technology is widely applied in semiconductor manufacturing. However, limitations remain, especially when dealing with specialized applications involving complex structural dimension or non-standard TSV configurations.

Prior art CN106403808A discloses a device and a method for measuring the morphology of through-hole silicon, comprising: an infrared laser light source configured to provide an illumination beam; an illumination unit configured to adjust the illumination beam and irradiate the illumination beam onto an etched surface or a non-etched surface of the through-hole silicon to be measured; an imaging detection unit configured to detect a diffraction angle spectrum signal generated by irradiation to the illumination beam onto a front surface or a back surface of the through-hole silicon to be measured; and a processing unit configured to obtain morphology information of the through-hole silicon to be measured based on the diffraction angle spectrum signal.

Prior art TWI807653B discloses an optical measurement system for high aspect ratio microstructure, comprising a light source module, an optical lens assembly, and a spatial modulation element. The light source module has a first characteristic dimension and is configured to generate a detection beam having a first divergence angle. The optical lens assembly is configured to receive the detection beam and project the detection beam onto an object to be measured. The spatial modulation element is disposed between the light source module and the optical lens assembly. The spatial modulation element includes an opening having a second characteristic dimension, and the detection beam passing through the center of the opening has a second divergence angle, wherein the product of the first characteristic dimension and the first divergence angle is approximately equal to or equal to the product of the second characteristic dimension and the second divergence angle.

### SUMMARY

The present invention provides an innovative method for detecting high aspect ratio micro-holes based on the principle of interface-enhanced frequency-doubled signal generation. The micro-hole includes, but is not limited to, a through-silicon via (TSV), a through-glass via (TGV), and a through-SiC via (TSiCV). A fundamental frequency light of a specific wavelength is scanned along an axial direction of the micro-hole to generate a strong interface-enhanced frequency-doubled signal at an interface between the micro-hole and another material (including but not limited to air). A micro-hole geometric structure image characterized by high resolution and visualization is thereby obtained. The micro-hole geometric structure image exhibits high-intensity and distinct interface-enhanced frequency-doubled signals distributed along the contour of the micro-hole, enabling direct observation of the micro-hole morphology and evaluation of micro-hole structural quality. The frequency-doubled signal is further analyzable to achieve high-precision measurement of micro-hole dimensional attributes, including size, shape, surface roughness, defects, and cracks. The described detection method is applicable to process monitoring and quality control of high aspect ratio micro-hole fabrication, offering broad application potential in microstructure analysis and advanced manufacturing.

### Technical Features of the Present Invention

A system for detecting high aspect ratio micro-holes using optical frequency doubling technology, comprising:
A fundamental frequency light configured to be scanned across a test sample along an X-axis and a Y-axis and to be directed into an interior of a micro-hole of the test sample along a Z-axis for scanning;
A photodetector configured to receive an optical signal generated by scanning the fundamental frequency light on a surface of the test sample and within the micro-hole of the test sample, and configured to convert the optical signal into an electrical signal, wherein the optical signal is a frequency-doubled signal of the fundamental frequency light;
A signal processing and imaging module operably coupled to the photodetector, the signal processing and imaging module being configured to acquire and process the electrical signal and to generate a micro-hole geometric structure image, wherein a high-intensity and distinct interface-enhanced frequency-doubled signal is presented at an interface junction between the micro-hole and another material.

A method for detecting high aspect ratio micro-holes using optical frequency doubling technology, comprising the following steps:
Providing a fundamental frequency light of a specific wavelength, wherein the fundamental frequency light has sufficient energy to excite a frequency-doubled signal at an interface between a micro-hole of a test sample and another material;
Performing a light beam scanning step along the axial direction of the micro-hole of the test sample, wherein the light beam scanning step ensures the fundamental frequency light to be scanned into an interface between the micro-hole and another material;
Capturing the frequency-doubled signal to generate a micro-hole geometric structure image, wherein the micro-hole geometric structure image exhibits a high-intensity and distinct interface-enhanced frequency-doubled signal at the interface between the micro-hole and another material, thereby presenting clear structural characteristics and defects of the micro-hole.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of the system of the present invention.

FIG. 2 is a first example of a micro-hole geometric structure image of the present invention.

FIG. 3 is a second example of a micro-hole geometric structure image of the present invention.

FIG. 4 is a cross-sectional image of the top portion of the micro-hole shown in FIG. 3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

The micro-holes described below include, but is not limited to, through silicon via (TSV), a through-glass via (TGV), and a through-SiC via (TSiCV).

A method for detecting high aspect ratio micro-holes using optical frequency doubling technology, comprising: scanning a fundamental frequency light of a specific wavelength along the axis of the micro-hole to generate strong interface-enhanced frequency-doubled signals at an interface between the micro-hole and another material (including, but not limited to, air), thereby obtaining a micro-hole geometric structure image characterized by high resolution and visualization, wherein the micro-hole geometric structure image exhibits a high-intensity and distinct interface-enhanced frequency-doubled signal along the contour of the micro-hole, thereby enabling direct visualization of the micro-hole morphology and assessment of the structural quality of the micro-hole.

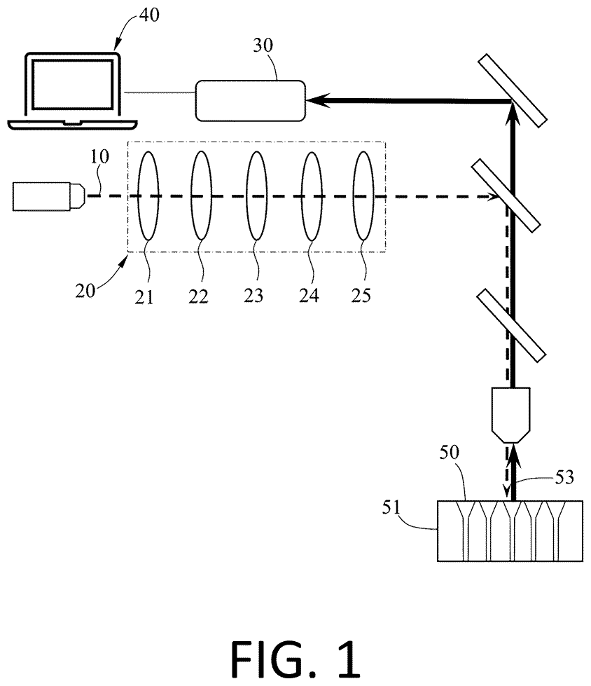

As shown in FIG. 1 and based on the aforementioned method, a system for detecting high aspect ratio micro-holes using optical frequency doubling technology is provided, the system comprising: a fundamental frequency light 10, a galvanometer system 20, a photodetector 30, and a signal processing and imaging module 40.

The fundamental frequency light 10 has a wavelength range from about 1200 nm to about 1800 nm, including, but not limited to, an ultrafast infrared light with a wavelength of 1560 nm. The fundamental frequency light 10 is configured to be scanned across a test sample 51 along an X-axis and a Y-axis and to be directed into an interior of a micro-hole 50 of the test sample 51 along a Z-axis for scanning.

The galvanometer system 20 includes, but is not limited to, a combination of a beam expander 21, an attenuator 22, a first lens 23, a galvanometer 24, and a second lens 25, wherein each of the beam expander 21, the attenuator 22, the first lens 23, the galvanometer 24, and the second lens 25 is disposed along the propagation direction of the fundamental frequency light 10. The galvanometer system 20 is used to convert the fundamental frequency light 10 in a single-point configuration into the fundamental frequency light 10 in a scanning configuration.

The beam expander 21 is used to adjust a beam size and a divergence angle of the fundamental frequency light 10 to a predetermined value or a specified range.

The attenuator 22 is used to reduce the power of the fundamental frequency light 10 to a predetermined value or a specified range, thereby protecting the test sample 51 and preventing damage caused by excessive energy.

The first lens 23 is used to focus the fundamental frequency light 10 passing through the attenuator 22 onto the galvanometer 24.

The galvanometer 24 is a high-reflectivity mirror mounted on a rotating axis. A driving circuit supplies the galvanometer 24 with the driving voltage and control signals to precisely control the rotational speed and angle of the galvanometer 24, thereby enabling precise scanning along the X-axis and the Y-axis.

The second lens 25 is used to focus the fundamental frequency light 10, transmitted through the galvanometer 24, onto the working surface of the test sample 51 along the X-axis and the Y-axis, the working surface being the location of the micro-hole 50.

The photodetector 30 is used to receive an optical signal 53 generated by the scanning of the micro-hole 50 using the fundamental frequency light 10. The optical signal 53 is a frequency-doubled signal of the fundamental frequency light 10. The photodetector 30 converts the optical signal 53 into an electrical signal and amplifies the electrical signal. The photodetector 30 includes a photomultiplier tube (PMT), the photomultiplier tube being capable of converting weak optical signals into measurable electrical currents and performing significant amplification. In the present invention, other devices capable of converting optical signal into electrical signal and performing amplification may also be used in place of the photomultiplier tube, including but not limited to a photodiode (PD), an avalanche photodiode (APD), and a charge-coupled device (CCD).

a signal processing and imaging module 40 operably coupled to the photodetector 30, the signal processing and imaging module 40 being configured to acquire and process the electrical signal and to generate a micro-hole geometric structure image 60.

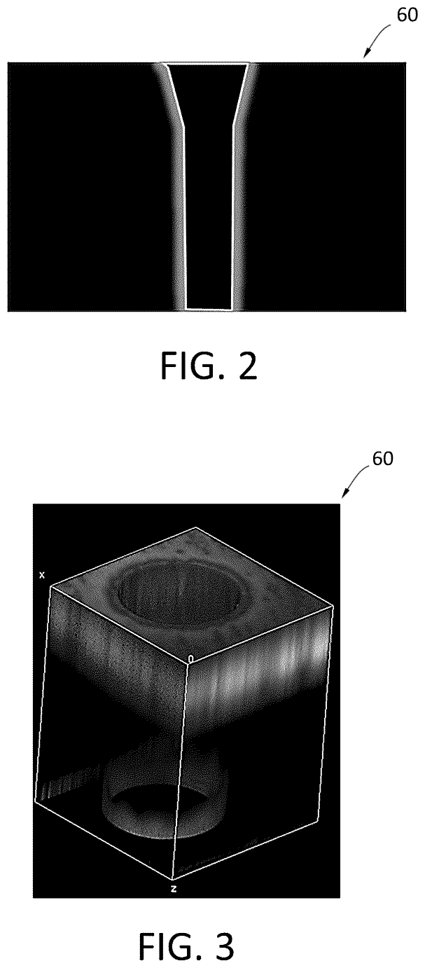

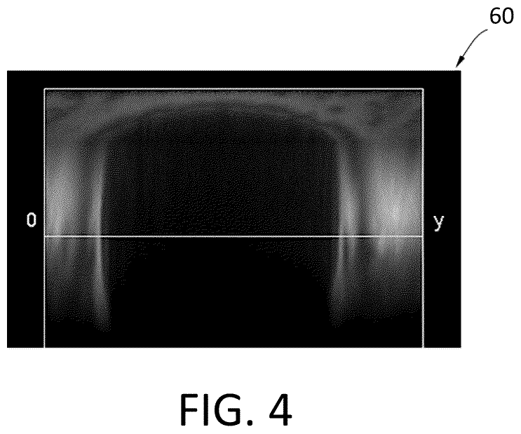

As shown in FIG. 2 to FIG. 4, the micro-hole geometric structure image 60 includes, but is not limited to, a cross-section image, a longitudinal section image, a two-dimensional image, and a three-dimensional image of the micro-hole 50. The micro-hole geometric structure image 60 is characterized by a high-intensity and distinct interface-enhanced frequency-doubled signal at an interface junction between the micro-hole 50 and another material, resulting in high-resolution visualization along the contour of the micro-hole 50. Based on the image, the morphology and structural quality of the micro-hole 50 can be intuitively evaluated. Furthermore, the frequency-doubled signal can be further analyzed to perform high-precision measurement of the hole size, shape, surface roughness, defects, and cracks. This method is applicable to process monitoring and quality control of high aspect ratio micro-holes 50.

Based on the foregoing, a method for detecting high aspect ratio micro-holes using optical frequency doubling technology, comprising the following steps:
Providing a fundamental frequency light of a specific wavelength, wherein the fundamental frequency light has sufficient energy to excite a frequency-doubled signal at an interface between a micro-hole of a test sample and another material (including, but not limited to, air);
Performing a light beam scanning step along the axial direction of the micro-hole of the test sample, wherein the light beam scanning step ensures the fundamental frequency light to be scanned into an interface between the micro-hole and another material;
Capturing the frequency-doubled signal to generate a micro-hole geometric structure image characterized by high resolution, wherein the micro-hole geometric structure image exhibits a high-intensity and distinct interface-enhanced frequency-doubled signal at the interface between the micro-hole and another material, thereby presenting clear structural characteristics and defects of the micro-hole.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A system for detecting high aspect ratio micro-holes using optical frequency doubling technology, comprising:
a fundamental frequency light configured to be scanned across a test sample along an X-axis and a Y-axis and to be directed into an interior of a micro-hole of the test sample along a Z-axis for scanning;
a photodetector configured to receive an optical signal generated by scanning the fundamental frequency light on a surface of the test sample and within the micro-hole of the test sample, and configured to convert the optical signal into an electrical signal, wherein the optical signal is a frequency-doubled signal of the fundamental frequency light; and
a signal processing and imaging module operably coupled to the photodetector, the signal processing and imaging module being configured to acquire and process the electrical signal and to generate a micro-hole geometric structure image, wherein the micro-hole geometric structure image has a high-intensity and distinct interface-enhanced frequency-doubled signal at an interface junction between the micro-hole and another material.

2. The system for detecting high aspect ratio micro-holes using optical frequency doubling technology according to claim 1, wherein the micro-hole geometric structure image includes a cross-section image, a longitudinal section image, a two-dimensional image, and a three-dimensional image of the micro-hole.

3. The system for detecting high aspect ratio micro-holes using optical frequency doubling technology according to claim 1, wherein a wavelength of the fundamental frequency light ranges from about 1200 nm to about 1800 nm.

4. The system for detecting high aspect ratio micro-holes using optical frequency doubling technology according to claim 3, wherein the fundamental frequency light is an infrared laser with the wavelength of 1560 nm.

5. The system for detecting high aspect ratio micro-holes using optical frequency doubling technology according to claim 1 further comprises a galvanometer system is configured to convert the fundamental frequency light in a single-point configuration into the fundamental frequency light in a scanning configuration.

6. The system for detecting high aspect ratio micro-holes using optical frequency doubling technology according to claim 5, wherein the galvanometer system includes, but is not limited to, a combination of a beam expander, an attenuator, a first lens, a galvanometer, and a second lens, wherein each of the beam expander, the attenuator, the first lens, the galvanometer, and the second lens is disposed along the propagation direction of the fundamental frequency light.

7. The system for detecting high aspect ratio micro-holes using optical frequency doubling technology according to claim 1, wherein the photodetector comprises any one or more of a photodiode (PD), an avalanche photodiode (APD), a charge-coupled device (CCD), or a photomultiplier tube (PMT).

8. A method for detecting high aspect ratio micro-holes using optical frequency doubling technology, comprising:
scanning a fundamental frequency light of a specific wavelength along the axis of the micro-hole to generate strong interface-enhanced frequency-doubled signals at an interface between the micro-hole and another material, thereby obtaining a micro-hole geometric structure image characterized by high resolution and visualization.

9. A method for detecting high aspect ratio micro-holes using optical frequency doubling technology, comprising the following steps:
Providing a fundamental frequency light of a specific wavelength, wherein the fundamental frequency light is configured to excite a frequency-doubled signal at an interface between a micro-hole of a test sample and another material;
Performing a light beam scanning step along the axial direction of the micro-hole of the test sample, wherein the light beam scanning step enables the fundamental frequency light to be scanned into an interface between the micro-hole and another material;
capturing the frequency-doubled signal to generate a micro-hole geometric structure image characterized by high resolution, wherein the micro-hole geometric structure image exhibits a high-intensity and distinct interface-enhanced frequency-doubled signal at the interface between the micro-hole and another material, thereby presenting clear structural characteristics and defects of the micro-hole.

10. The method for detecting high aspect ratio micro-holes using optical frequency doubling technology according to claim 9, wherein a wavelength of the fundamental frequency light ranges from about 1200 nm to about 1800 nm.

11. The method for detecting high aspect ratio micro-holes using optical frequency doubling technology according to claim 10, wherein the wavelength of the fundamental frequency light is 1560 nm.

12. The method for detecting high aspect ratio micro-holes using optical frequency doubling technology according to claim 9, wherein the light beam scanning step comprises scanning along an X-axis, a Y-axis and a Z-axis of the test sample, wherein the scanning along the Z-axis is performed as a depth scan into the micro-hole.

13. The method for detecting high aspect ratio micro-holes using optical frequency doubling technology according to claim 9, wherein the light beam scanning step comprises adjusting a power and a beam size of a nonlinear excitation light beam to prevent excessive energy from damaging the test sample.
